(19) United States
(12) Patent Application Publication
(10) Pub. No.: US 2016/0299536 A1
(43) Pub. Date: Oct. 13, 2016

(54) ELECTRONIC DEVICE

(71) Applicant: Panasonic Intellectual Property Management Co., Ltd., Osaka (JP)

(72) Inventors: Takeshi MORI, Osaka (JP); Akira IWAMOTO, Osaka (JP); Kenichi SHINDO, Osaka (JP)

(21) Appl. No.: 15/190,391

(22) Filed: Jun. 23, 2016

Related U.S. Application Data
(63) Continuation of application No. PCT/JP2014/004228, filed on Aug. 19, 2014.

(30) Foreign Application Priority Data
Dec. 25, 2013 (JP) 2013-267612

(51) Int. Cl. G06F 1/16; H04R 1/08

(52) U.S. Cl. CPC G06F 1/1656; G06F 1/1626; G06F 1/1637; G06F 1/1684; H04R 1/08; H04R 2499/11

(57) ABSTRACT

An electronic device has a microphone. The electronic device comprises a display member, an inner case disposed on a non-display face side of the display member and housing the microphone, and an outer case surrounding a side portion of the display member and housing the inner case. A gap is provided between the side portion of the display member and the outer case, the inner case has an opening formed in the vicinity of the gap, the microphone is disposed in the vicinity of the opening in a space within the inner case.

### CROSS-REFERENCE TO RELATED APPLICATIONS

This is a continuation application of International Application No. PCT/JP2014/004228, with an international filing date of Aug. 19, 2014, which claims priorities of Japanese Patent Application No.: 2013-267612 filed on Dec. 25, 2013, the content of which is incorporated herein by references.

### BACKGROUND

1. Technical Field

The present disclosure relates to an electronic device having a microphone.

2. Related Art

An electronic device such as a tablet computer may include a microphone for inputting sound. For example, an electronic device described in JP-A-2013-55436 is an electronic device including a microphone.

JP-A-2013-55436 discloses that a hole is formed in a case of the electronic device so as to introduce a sound outside the case into the case.

### SUMMARY

An electronic device may include an inner case housing electronic components and so on, and an outer case housing the inner case. A microphone may be housed in the inner case.

The present disclosure provides a structure guiding sound to a microphone in an electronic device including the inner case housing the microphone and so on, and the outer case housing the inner case.

An electronic device according to the present disclosure has a microphone. The electronic device comprises a display member, an inner case disposed on a non-display face side of the display member and housing the microphone, and an outer case surrounding a side portion of the display member and housing the inner case. A gap is provided between the side portion of the display member and the outer case, the inner case has an opening formed in the vicinity of the gap, the microphone is disposed in the vicinity of the opening in a space within the inner case.

According to the present disclosure, a sound generated outside the electronic device can be transmitted to the microphone through the gap between the side portion of the display member and the outer case and through the opening disposed in the inner case in the vicinity of the gap. In this case, since the opening of the inner case is disposed in the vicinity of the gap between the side portion of the display member and the outer case, the sound entering through the gap can efficiently be transmitted to the microphone.

### BRIEF DESCRIPTION OF DRAWINGS

FIG. 1 is a perspective view of an upper face (display face) side of a tablet terminal apparatus according to an embodiment of the present disclosure.

FIG. 2 is a perspective view of a lower face (back face) side of the tablet terminal apparatus according to the embodiment of the present disclosure.

FIG. 3 is a perspective cross-sectional view taken along a line A-A of FIG. 1.

FIG. 4 is a partially enlarged perspective view of an inner case of the tablet terminal apparatus according to the embodiment of the present disclosure.

FIG. 5 is a schematic for explaining a sound guiding structure to a microphone of the tablet terminal apparatus according to the embodiment of the present disclosure.

### DETAILED DESCRIPTION OF PREFERRED EMBODIMENT

### First Embodiment

An embodiment will be described in detail with arbitrary reference to the drawings. No description however may be made that is more detailed than necessary. For example, no detailed description of already well known items and no repeated description for substantially same configurations may be made. This is to avoid unnecessary redundancy of the following description and is to facilitate the understanding by those skilled in the art.

The inventor(s) provide(s) the accompanying drawings and the following description for those skilled in the art to sufficiently understand the present disclosure, and do(es) not intend to limit the subject matter described in claims by the drawings and the description.

In the following description, terms each meaning a specific direction (for example, “above”, “under”, “left”, “right”, and other terms including any one of these) maybe used while the use of those terms is to facilitate the understanding of the present disclosure with reference to the drawings, and the present disclosure should not be interpreted being limited by the meaning of each of those terms.

The embodiment of the present disclosure described below takes an example of application to a what-is-called tablet-type portable information terminal apparatus (hereinafter, arbitrarily, referred to as “tablet terminal apparatus” or simply as “apparatus”) . The tablet terminal apparatus includes a CPU, a storing device such as a RAM, a ROM, or an SSD, an input unit, and various types of external interface, and realizes predetermined functions by arithmetic processing by the CPU based on programs stored in the storing apparatus.

### 1. Configuration

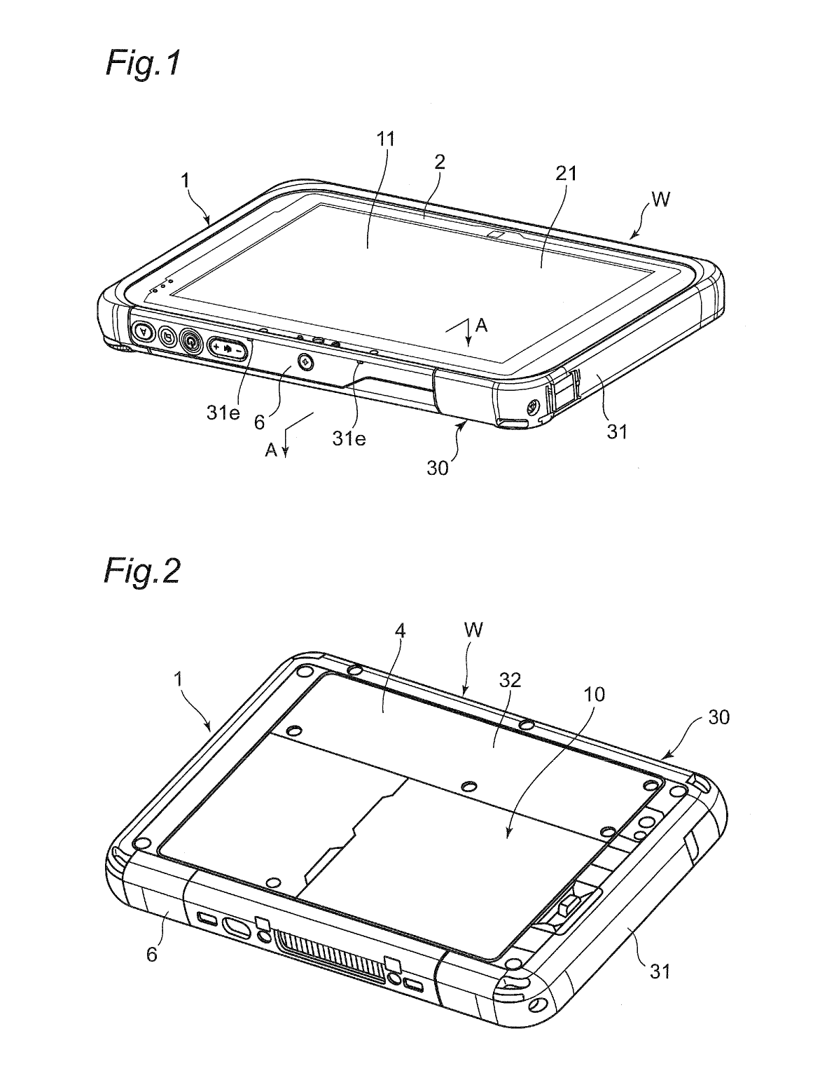

FIG. 1 is a perspective view of an upper face (a display face) of the tablet terminal apparatus as the electronic device according to this embodiment. FIG. 2 is a perspective view of a lower face (a back face) of the tablet terminal apparatus.

As depicted in these figures, a tablet terminal apparatus W according to this embodiment is formed into a substantially rectangular shape in a planar view and has a predetermined thickness (height). A display member 11 is disposed on an upper face portion 2 of the tablet terminal apparatus W. The display member 11 includes a glass plate 21 making up the upper face thereof. The display member 11 is a liquid crystal display apparatus, for example. The display member 11 may be a touch panel display apparatus enabling a user to perform touch input. A battery pack 10 is mounted on a lower face portion 4 (the back face side) of the tablet terminal apparatus W. The battery pack 10 is provided detachably according to a user operation on the battery lock operating member. Various operation switches and various connectors are disposed on a side face portion 6 of the tablet terminal apparatus W.

The tablet terminal apparatus W includes as a housing 1 an outer case 30 constituting an outer face thereof except the upper face portion constituted by the glass plate 21. The outer case 30 includes a side face member 31 constituting the side face portion 6 and a lower face member 32 constituting the lower face portion 4. The side face member 31 has a frame-like shape in a planar view thereof. The members constituting the outer case 30 are made from, for example, a resin such as, for example, elastomer.

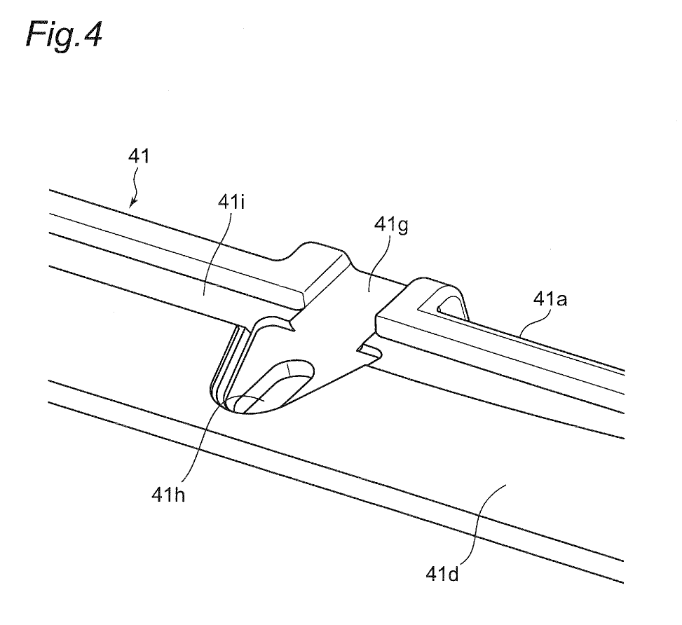

As depicted in FIG. 4, an inner case 40 is accommodated in an inner space surrounded by the outer case 30 and the glass plate 21. The inner case 40 is configured to have a box-like shape to be able to accommodate various electronic parts. The inner case 40 includes an upper member 41 disposed on the glass plate 21 side, and a lower member 42 disposed on the opposite side of the glass plate 21. The inner case 40 constitutes the frame (framework material) of the tablet terminal apparatus W, and is formed using a metal material such as, for example, magnesium (Mg) to secure the mechanical rigidity and so on. In the following description, the upper member 41 and the lower member 42 will not be distinguished from each other and will be described as the inner case 40.

In the tablet terminal apparatus W of this embodiment, a microphone 53 acquiring a sound outside the tablet terminal apparatus W is disposed in the inner case 40. A configuration for the microphone 53 acquiring a sound outside the tablet terminal apparatus W will hereinafter be described.

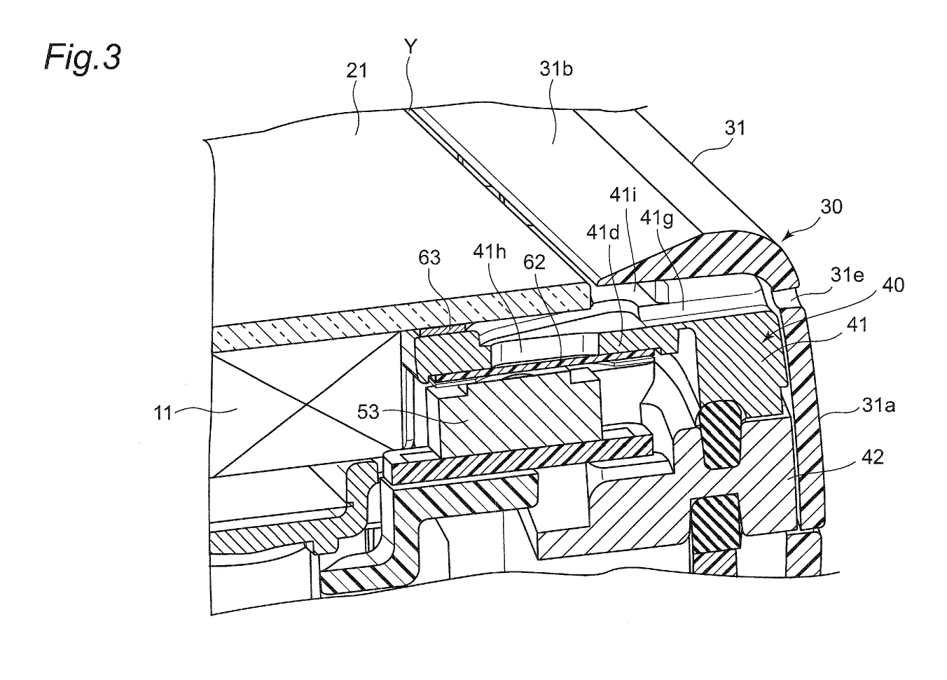

FIG. 3 is a cross-sectional view taken along a line A-A of FIG. 1. As depicted in FIG. 3, the microphone 53 is disposed in the inner case 40 in the vicinity of a side wall portion 41a of the inner case 40.

The side face member 31 of the outer case 30 includes a side wall portion 31a, an upper wall portion 31b extending substantially perpendicularly from an upper end of the side wall portion 31a, and a lower wall portion (not depicted) extending substantially perpendicularly from a lower end of the side wall portion 31a, and has a cross section formed into a substantially U-shape. A predetermined amount of a gap Y is formed between an end portion of the upper wall portion 31b of the side face member 31 and an end portion of the glass plate 21 disposed adjacently to the upper wall portion 31b.

On the side wall portion 31a of the side face member 31 of the outer case 30, a hole 31e is provided for introducing a sound of a space outside the tablet terminal apparatus W into the microphone 53. The hole 31e is formed at a position in the side wall portion 31a at the shortest distance from the microphone 53, that is, at a position where a perpendicular line from the center of the microphone 53 intersects the side wall portion 31a.

FIG. 4 is a perspective view of a structure of a portion near the hole 31e of the outer case 30. As depicted in FIGS. 3 and 4, the inner case 40 is provided with an upper wall portion 41d parallel to a principal plane of the glass plate 21, and the upper wall portion 41d has an opening 41h formed in the vicinity of the gap Y. The microphone 53 is disposed in the vicinity of the opening 41h in the inner case 40. Specifically, the microphone 53 is disposed in the vicinity of the opening 41h on the lower face (inner face) side of the upper wall portion 41d.

A communication groove 41g from the opening 41h to the hole 31e of the outer case 30 is formed in an upper face (outer face) of the upper wall portion 41d of the inner case 40. The communication groove 41g is for guiding the sound input from the hole 31e of the outer case 30 to the microphone 53. The communication groove 41g is formed such that a portion on the opening 41h side has the width made larger toward the hole 31e.

A sound guiding groove 41i is formed in the upper face of the upper wall portion 41d of the inner case 40 and extends in substantially parallel with the gap Y between the end portion of the upper wall portion 31b of the side face member 31 of the outer case 30 and the end portion of the glass plate 21. The sound guiding groove 41i is formed at a position substantially under the gap Y. The sound guiding groove 41i is connected to the communication groove 41g.

The upper face of the upper wall portion 41d of the inner case 40 and a lower face of the glass plate 21 are sealed by an adhesive 63.

A waterproof sheet 62 preventing the intrusion of water from the opening 41h is affixed to a lower face of the upper wall portion 41d of the inner case 40. A sheet made of a material capable of transmitting sound is used for the waterproof sheet 62.

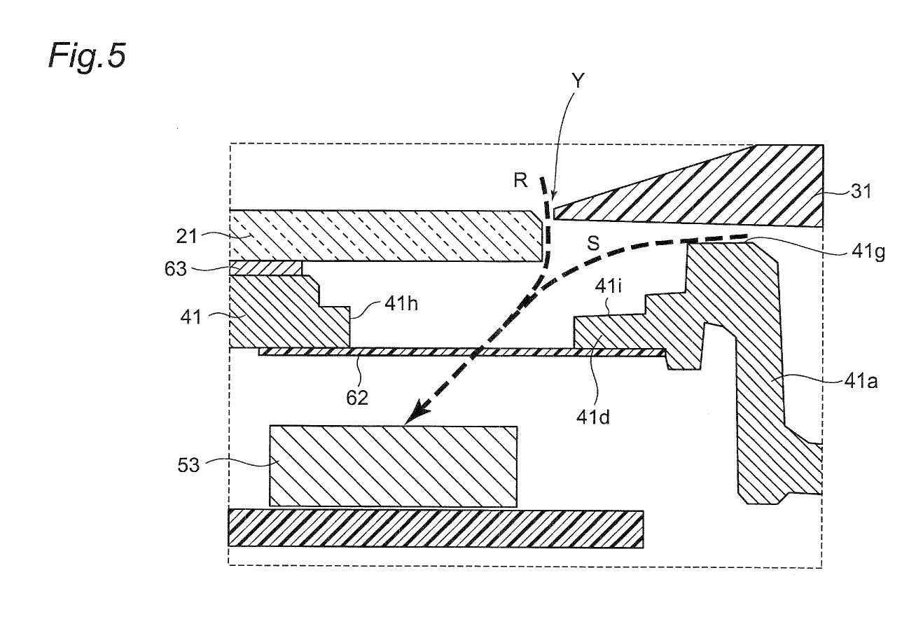

FIG. 5 is a schematic for explaining a structure of guiding to the microphone 53 a sound of a space outside the tablet terminal apparatus W of this embodiment. According to this embodiment, the sound is introduced into the tablet terminal apparatus W through the gap Y between the side face member 31 of the outer case 30 and the glass plate 21 as indicated by a broken line R and reaches the microphone 53 through the sound guiding groove 41i, the communication groove 41g, and the opening 41h.

The sound is introduced through the hole 31e of the side face member 31 of the outer case 30 depicted in FIG. 3 and reaches the microphone 53 through the communication groove 41g and the opening 41h as indicated by a broken line S of FIG. 5.

### 2. Conclusion

The tablet terminal apparatus W of this embodiment has the microphone 53. The tablet terminal apparatus W includes the display member 11, the inner case 40 disposed on the non-display face side of the display member 11 and housing the microphone 53, and the outer case 30 surrounding the side portion of the display member 11 and housing the inner case 40. The gap Y is provided between the side portion (the glass plate 21) of the display member 11 and the outer case 30, and the inner case 40 has the opening 41h formed in the vicinity of the gap Y while the microphone 53 is disposed in the vicinity of the opening 41h in a space within the inner case 40.

With this configuration, the sound generated outside the tablet terminal apparatus W can be transmitted to the microphone 53 through the gap Y between the side portion (the glass plate 21) of the display member 11 and the outer case 30 and through the opening 41h disposed in the inner case 40 in the vicinity of the gap Y. In this case, since the opening 41h of the inner case 40 is disposed in the vicinity of the gap Y between the side portion of the display member 11 and the outer case 30, the sound entering through the gap Y can efficiently be transmitted to the microphone 53.

The tablet terminal apparatus W of this embodiment further includes the waterproof sheet 62 covering the opening 41h.

With this configuration, the intrusion of water from the opening 41h can be prevented.

In this embodiment, the sound guiding groove 41i guiding the sound introduced from the gap Y to the opening 41h is formed in the outer face of the inner case 40.

With this configuration, the sound introduced from the gap Y can favorably be guided to the microphone 53 through the sound guiding groove 41i and the opening 41h.

In this embodiment, the hole 31e connected to the communication groove 41g of the inner case 40 is formed in the outer case 30.

With this configuration, the sound generated outside the tablet terminal apparatus W can favorably be guided to the microphone 53 through the hole 31e of the outer case 30, the sound guiding groove 41i, and the opening 41h.

### Other Embodiments

As above, the first embodiment has been described as an example of the technique disclosed in this application. The technique in the present disclosure is however not limited to this and is applicable to an embodiment to which a change, replacement, addition, omission, etc., are arbitrarily made.

In this embodiment, the case is described where the electronic device is the tablet terminal apparatus. The electronic device is however not limited to this. The present disclosure is applicable widely to electronic devices such as a notebook computer, an electronic notebook, and an electronic gaming machine.

As above, the embodiments have been described as examples of the technique in the present disclosure. To do this, the accompanying drawings and the detailed description have been provided.

The components depicted in the accompanying drawings and described in the detailed description may therefore include not only the components essential for solving the problem but also the components not essential for solving the problem to exemplify the technique. It should not therefore be readily recognized that those non-essential components are essential based on the fact that those non-essential components are depicted in the accompanying drawings and described in the detailed description.

The embodiments are to exemplify the technique in the present disclosure and various changes, replacements, additions, omissions, etc., can therefore be made to the embodiments within the scope of claims or a scope equivalent thereto.

### INDUSTRIAL APPLICABILITY

The present disclosure is widely applicable to portable electronic devices such as notebook computers, tablet computers, personal digital assistances, and electronic game apparatuses.

1. An electronic device having a microphone comprising:
a display member;
an inner case disposed on a non-display face side of the display member and housing the microphone; and
an outer case surrounding a side portion of the display member and housing the inner case, wherein
a gap is provided between the side portion of the display member and the outer case,
the inner case has an opening formed in the vicinity of the gap,
the microphone is disposed in the vicinity of the opening in a space within the inner case.

2. The electronic device of claim 1, further comprising
a waterproof sheet covering the opening.

3. The electronic device of claim 1, wherein
a groove guiding a sound introduced from the gap to the opening is formed in an outer face of the inner case.

4. The electronic device of claim 3, wherein
a hole connected to the groove of the inner case is formed in the outer case.

5. The electronic device of claim 1, wherein
the electronic device is a tablet computer.
